(19) United States
(12) Patent Application Publication
(10) Pub. No.: US 2011/0221869 A1
(43) Pub. Date: Sep. 15, 2011

(54) IMAGING DEVICE, DISPLAY METHOD AND RECORDING MEDIUM

(75) Inventors: Takashi Yamaya, Tokyo (JP); Masaaki Kikuchi, Tokyo (JP)

(73) Assignee: CASIO COMPUTER CO., LTD., Tokyo (JP)

(21) Appl. No.: 13/047,116

(22) Filed: Mar. 14, 2011

(30) Foreign Application Priority Data
Mar. 15, 2010 (JP) 2010-058483

(51) Int. Cl. H04N 13/02

(52) U.S. Cl. 348/47; 348/E13.074

(57) ABSTRACT

A finder display processing unit displays a finder image on a finder screen, measures the distance through triangulation from a stereo camera to a part of a subject expressed in a designated region on the finder image, and designates the shortest distance and the farthest distance from the stereo camera to the subject on the basis of the distance acquired through distance measurement. A finder display processing unit specifies as an effective range candidate a range where the imaging ranges of the first imaging unit and a second imaging unit overlap, specifies an effective range candidate at the shortest distance and an effective range candidate at the farthest distance on the first photographed image, and specifies the range where these effective range candidates overlap as the effective range. The finder display processing unit displays on the finder screen information indicating the specified effective range.

### CROSS-REFERENCE TO RELATED APPLICATION

This application claims the benefit of Japanese Patent Application 2010-58483, filed Mar. 15, 2010, the entire disclosure of which is incorporated by reference herein.

### FIELD

This application relates generally to an imaging device, a display method and a non-transitory computer-readable recording medium storing a program, and more particularly, to an imaging device, a display method and a non-transitory computer-readable recording medium storing a program, all suitable for modeling using a stereo camera.

### BACKGROUND

As three-dimensional (3D) expressions using computer graphics have become more widely used, more realistic 3D expressions have been sought. To meet such demands, a method of creating 3D modeling data by imaging actual three-dimensional objects using a camera has been established. In this case, a so-called compound-eye camera (stereo camera) has been used in which an optical axis gap is established corresponding to parallax in order to recognize the three-dimensional position of three-dimensional objects.

With this kind of stereo camera, two imaging units with differing optical axis positions are used. For this reason, the angle of view of each imaging unit has an area that can only be imaged from one of the imaging units, in other words an area where there is no overlap in the angle of view of the two imaging units (a so-called “non-overlap area”). In this case, when the subject that is the object of modeling falls in a non-overlap area, it is impossible to accurately undertake shape calculations for this subject. In other words, if the subject is not contained in the area where the angle of view of the two imaging units overlap (the so-called “overlap area”), it is impossible to make the accurate shape calculations necessary for 3D modeling.

When a stereo camera is composed of a digital camera, the viewfinder image is displayed on a rear-surface monitor or the like, but the image displayed typically uses that imaged by one of the imaging units. Hence, it is impossible to confirm at the time of imaging whether or not the framing is such that the subject is contained within the overlap area.

On the other hand, a method has been proposed for specifying the overlap area on the basis of the distance (that is to say the base line length) between the imaging elements (between lenses) and the imaging parameters (zoom ratio and the like). If such methods are used, it is possible to realize an action such that the photographer can confirm whether or not the subject is contained within the overlap area.

The scope of the overlap area changes depending on the distance to the subject. Accordingly, in order to specify the overlap area more accurately, it is necessary to make measurements taking into consideration the depth of the subject. In contrast, with the conventional method, the distance to the subject is not given special consideration, so when shooting three-dimensional objects for 3D modeling, there are times when the specification of the overlap area is inaccurate.

In addition, it is possible to estimate the distance to the subject based on the focal length of a camera's AF (auto focus), but when the depth of the subject is taken into consideration, errors in the subject field depth can occur. For this reason, when making measurements that take the subject's depth into consideration, it is necessary for errors in subject field depth to be reflected in measurement results from AF, but factors determining subject field depth are complex, so it is extremely difficult to accurately reflect errors corresponding to the depth of the subject.

Furthermore, with conventional methods, it is impossible to distinguish between the overlap area (area where shape measurement is possible) and the non-overlap area (area where shape measurement is impossible). In this case, because the subject that is the object of 3D modeling is a three-dimensional object, there are times when the determination is that shape measurement is not possible despite shape measurement being possible in actuality, and times when the determination is that shape measurement is possible despite shape measurement not being possible in actuality.

For example, when the error in the subject field depth is set larger than that corresponding to the depth of the subject, even if the subject is in reality in the non-overlap area, the determination is made that a shape measurement is possible and imaging occurs in that state. In this case, it is impossible to generate modeling data for the part in the non-overlap area, forcing imaging to be redone.

On the other hand, when the error in the subject field depth is set smaller than that corresponding to the depth of the subject, even if the subject is in reality in the overlap area, the determination is that shape measurement is impossible. In this case, useless work not originally necessary is forced on the photographer, such as reviewing imaging conditions, even though in reality imaging could succeed under existing conditions.

That is to say, when errors in the subject field depth occur that take the subject's depth into consideration, precision in measurements with the AF are insufficient, causing the above-described problems. In other words, when accurate measurements taking the subject depth into consideration cannot be made, specification of the overlap area becomes inaccurate and as a result imaging efficiency declines markedly.

### SUMMARY

In consideration of the foregoing, it is an object of the present invention to provide an imaging device, a display method and a non-transitory computer-readable recording medium for storing programs with which imaging for 3D modeling can be efficiently accomplished.

In order to achieve the above and other objects, the imaging device according to a first aspect of the present invention comprises:

a stereo camera comprises a first imaging unit and a second imaging unit;

a finder display unit for displaying a first photographed image obtained through imaging by the first imaging unit on a finder screen as a finder image;

a distance measurement unit for measuring through triangulation a distance from the stereo camera to a part of a subject represented in a region indicated on the finder image;

a distance designation unit for designating a shortest distance and a farthest distance from the stereo camera to the subject on the basis of the distance obtained by distance measurement; an effective range candidate specifying unit for specifying as effective range candidates ranges where the imaging ranges of the first imaging unit and the second imaging unit overlap; and

an effective range specifying unit for specifying the effective range candidate at the shortest distance and the effective range candidate at the farthest distance on the first photographed image, and specifying as the effective range a range where these effective range candidates overlap;

wherein the finder display unit displays on the finder screen information indicating the specified effective range.

In order to achieve the above and other objects, the display method according to a second aspect of the present invention is display method for accomplishing, in an imaging device comprising a stereo camera that comprises a first imaging unit and a second imaging unit, a finder display that makes an absence or presence of framing recognizable when a first photographed image obtained through imaging by the first imaging unit is displayed on a finder screen as a finder image, the display method comprising:

measuring a distance from the stereo camera to a part of a subject represented in a region designated on the finder image using triangulation;

designating the shortest distance and the farthest distance from the stereo camera to the subject on the basis of the distance obtained by the distance measurement;

specifying the range where the imaging ranges of the first imaging unit and the second imaging unit overlap as an effective range candidate;

specifying the effective range candidate at the shortest distance and the effective range candidate at the farthest distance on the first photographed image;

specifying the range where the effective range candidates overlap as the effective range; and

displaying information indicating the specified effective range on the finder screen.

In order to achieve the above and other objects, a non-transitory computer-readable recording medium according to a third aspect of the present invention is a recording medium having stored thereon a program that is executable by a computer of an imaging device which comprises a stereo camera and a finder display unit, wherein the stereo camera comprises a first imaging unit and a second imaging unit, wherein the finder display unit is configured to display as a finder image a first photographed image obtained through imaging by the first imaging unit on a finder screen, wherein the program is executable by the computer to cause the computer to perform functions comprising:

measuring a distance from the stereo camera to a part of a subject represented in a region designated on the finder image using triangulation;

designating the shortest distance and the farthest distance from the stereo camera to the subject on the basis of the distance obtained by the distance measurement;

specifying the range where the imaging ranges of the first imaging unit and the second imaging unit overlap as an effective range candidate;

specifying the effective range candidate at the shortest distance and the effective range candidate at the farthest distance on the first photographed image;

specifying the range where the effective range candidates overlap as the effective range; and

displaying information indicating the specified effective range on the finder screen.

### BRIEF DESCRIPTION OF THE DRAWINGS

A more complete understanding of this application can be obtained when the following detailed description is considered in conjunction with the following drawings, in which:

FIG. 1 is a drawing showing the external composition of a digital camera according to an embodiment of the present invention;

FIG. 2 is a block diagram showing the composition of the digital camera shown in FIG. 1;

FIG. 3 is a function block diagram showing the functions realized through the controller shown in FIG. 2;

FIG. 4 is a flowchart explaining the imaging process for 3D modeling according to an embodiment of the present invention;

FIG. 5A is a diagram used to explain the actions of the imaging process for 3D modeling shown in FIG. 4, and shows an example of the imaging scene envisioned by an embodiment of the present invention;

FIGS. 5B and 5C are drawings used to explain the actions of the imaging process for 3D modeling as shown in FIG. 4, and show an example of the AF frame designation screen displayed in the imaging process for 3D modeling;

FIG. 6 is a flowchart explaining the high-accuracy distance measurement process executed in the imaging process for 3D modeling shown in FIG. 4;

FIG. 7 is a flowchart explaining the finder display process executed by the imaging process for 3D modeling shown in FIG. 4;

FIG. 8A is a drawing used to explain the imaging range in the digital camera according to an embodiment of the present invention, and shows an example of the imaging range when the angle of view is wide;

FIG. 8B is a drawing used to explain the imaging range in the digital camera according to an embodiment of the present invention, and shows an example of the imaging range when the angle of view is narrow;

FIG. 9A is a drawing used to explain the relationship between the imaging range and the distance in the examples shown in FIGS. 8A and 8B, and schematically shows the relationship between the measurement-possible range and the measurement-impossible range depending on the shortest distance and the farthest distance to the subject;

FIG. 9B is a drawing used to explain the relationship between the imaging range and the distance in the examples shown in FIGS. 8A and 8B, and shows conditions when the subject is in the measurement-possible range in this case;

FIG. 9C is a drawing used to explain the relationship between the imaging range and the distance in the examples shown in FIGS. 8A and 8B, and shows conditions when the subject is in the measurement-impossible range in this case;

FIG. 10A is a drawing used to explain the action of applying the relationship between the distance and the imaging range shown in FIGS. 9A through 9C applied to the photographed image, and schematically shows the relationship among the measurement-possible range, the measurement-impossible range, the shortest distance and the farthest distance in the imaging unit used as the finder image;

FIG. 10B is a drawing used to explain the action of applying the relationship between the distance and the imaging range shown in FIGS. 9A through 9C applied to the photographed image, and shows an example when the measurement-possible range at the shortest distance is applied to the photographed image;

FIG. 10C is a drawing used to explain the action of applying the relationship between the distance and the imaging range shown in FIGS. 9A through 9C applied to the photographed image, and shows an example when the measurement-possible range at the farthest distance is applied to the photographed image;

FIG. 10D is a drawing used to explain the action of applying the relationship between the distance and the imaging range shown in FIGS. 9A through 9C applied to the photographed image, and shows an example of the measurement-possible range, the measurement-unknown range and the measurement-impossible range specified on the basis of this;

FIG. 11A is a drawing used to explain the actions in the finder display process shown in FIG. 7, and shows an example of an image that is the object of stereo matching using the measurement-unknown range;

FIG. 11B is a drawing used to explain the actions in the finder display process shown in FIG. 7, and shows an example of the part matched through stereo matching;

FIG. 11C is a drawing used to explain the actions in the finder display process shown in FIG. 7, and shows an example of the expanded measurement-possible range;

FIG. 12A is a drawing used to explain the actions in the finder display process shown in FIG. 7, and shows an example of the finder display when the subject as a whole is imaged by even the second imaging unit;

FIG. 12B is a drawing used to explain the actions in the finder display process shown in FIG. 7, and shows an example of the finder display when a portion of the subject is imaged by the second imaging unit;

FIG. 12C is a drawing used to explain the actions in the finder display process shown in FIG. 7, and shows an example of the finder display in this case; and

FIGS. 13A and 13B is a drawing used to explain a second embodiment of the present invention, and shows a display example of the AF frame specification screen in the second embodiment.

### DETAILED DESCRIPTION

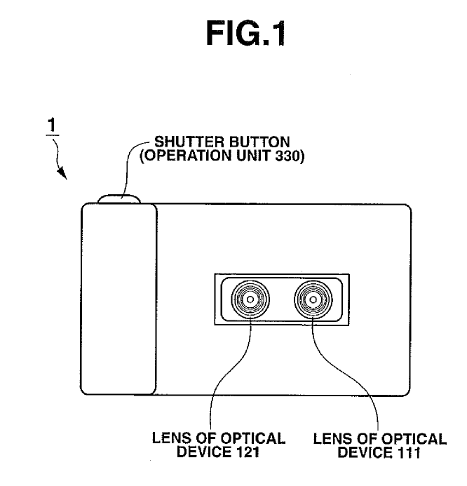

The preferred embodiments of the present invention are described below with reference to the drawings. In the preferred embodiments, examples are shown of the case wherein the present invention is implemented through a digital still camera (hereafter referred to as the digital camera). A digital camera 1 according to the present embodiment is one equipped with those functions possessed by a typical digital still camera, but as shown in FIG. 1, is a so-called compound-eye camera (stereo camera) equipped with two compositions for imaging.

The digital camera 1 having this kind of compound-eye camera compositions has a function for accomplishing three-dimensional modeling (3D modeling) using the images photographed.

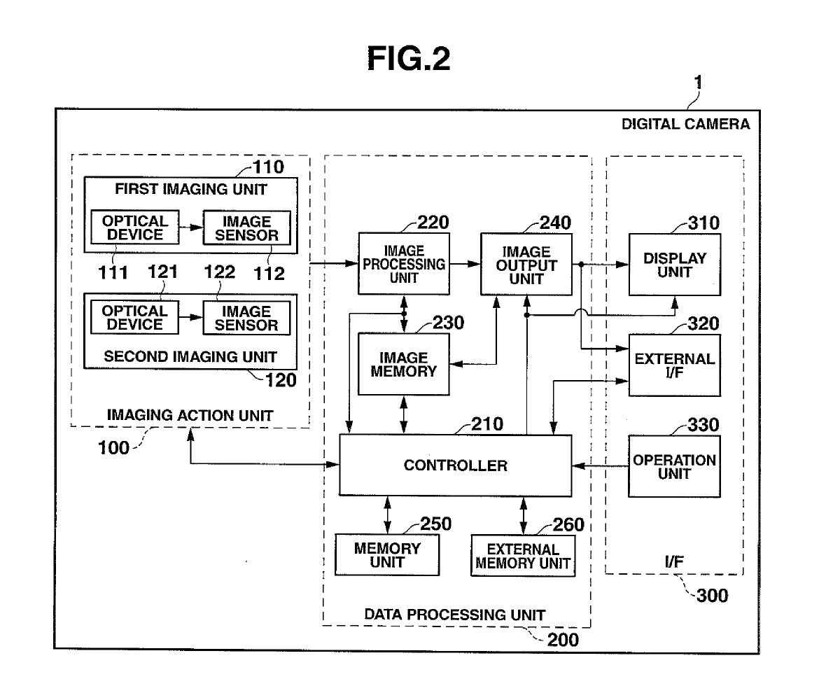

The composition of this digital still camera 1 is explained with reference to FIG. 2. FIG. 2 is a block diagram showing the composition of the digital camera 1 according to the preferred embodiments of the present invention. The digital camera 1 according to the present embodiment is composed of an imaging action unit 100, a data processing unit 200, an interface (I/F) 300 and the like.

The imaging action unit 100 accomplishes actions during imaging by the digital camera 1, and as shown in FIG. 2 is composed of a first imaging unit 110 and a second imaging unit 120.

The first imaging unit 110 and the second imaging unit 120 are components that accomplish the imaging action of the digital camera 1. As described above, the digital camera 1 according to the present embodiment is a compound-eye camera and thus has a composition possessing the first imaging unit 110 and the second imaging unit 120, but the first imaging unit 110 and the second imaging unit 120 have the same composition. Hereafter, reference numbers in the 110s are attached to the composition referring to the first imaging unit 110 and reference numbers in the 120s are attached to the composition referring to the second imaging unit 120, and in these reference numbers, those having the same ones digit indicate the same composition.

As shown in FIG. 2, the first imaging unit (second imaging unit 120) is composed of an optical device 111 (121) and an image sensor 112 (122).

The optical device 111 (121) includes, for example, a lens, a diaphragm mechanism, a shutter mechanism and the like, and accomplishes optical actions relating to imaging. That is to say, through the action of the optical device 111 (121), incident light is condensed and optical elements relating to angle of view, focus and exposure, such as focal length, aperture stop and shutter speed, are adjusted.

The shutter mechanism included in the optical device 111 (121) is a so-called mechanical shutter, and when the shutter action is accomplished only through the action of the image sensor, the shutter mechanism need not be included in the optical device 111 (121).

The image sensor unit 112 (122) is composed of an image sensor that generates an electrical signal corresponding to the incident light condensed by the optical device 111 (121), such as a CCD (Charge Coupled Device) or a CMOS (Complimentary Metal Oxide Semiconductor). The image sensor unit 112 (122) generates and outputs to a data processing unit 200 an electrical signal corresponding to the received light by accomplishing photoelectric conversion.

As described above, the first imaging unit 110 and the second imaging unit 120 have the same composition. More specifically, these are the same in all specifications, including focal length f of the lens, F-value, stop range of the diaphragm mechanism, size and pixel count of the image sensor, arrangement and surface area of pixels, and so forth.

The digital camera 1 possessing this kind of first imaging unit 110 and second imaging unit 120 is composed with the lens composed in the optical device 111 and the lens composed in the optical device 121 formed on the same surface on the outside surface of the digital camera 1, as shown in FIG. 1.

The two lenses (light-receiving units) are arranged so that the center positions are collinear in the horizontal direction when the digital camera 1 is held horizontally with the shutter button toward the top. More specifically, the optical axis of the first imaging unit 110 and the optical axis of the second imaging unit 120 are parallel (angle of convergence is 0) and the epipolar lines match. In other words, when the first imaging unit 110 and the second imaging unit 120 are operated simultaneously, images of the same subject are imaged, but the optical axis position in each image is shifted in the sideways direction.

The data processing unit 200 processes electrical signals generated by the imaging action of the first imaging unit 110 and the second imaging unit 120 to create digital data expressing the photographed image, and accomplishes image processing on the photographed image. As shown in FIG. 2, the data processing unit 200 is composed of a controller 210, an image processing unit 220, an image memory 230, an image output unit 240, a memory unit 250 and an external memory unit 260.

The controller 210 is composed of a processor such as a CPU (Central Processing Unit) and a main memory device such as RAM (Random Access Memory), and controls the various part of the digital camera 1 by executing programs stored in the below-described memory unit 250. In addition, in the present embodiment the functions according to the below-described various processes are realized by the controller 210 by executing prescribed programs. In the present embodiment, processes related to 3D modeling are also accomplished by the controller 210, but the composition may be such that this is accomplished by a specialty processor independent of the controller 210.

The image processing unit 220 is composed of an ADC (Analog-Digital Converter), a buffer memory, an image processing processor (a so-called image processing engine) or the like, and creates digital data showing the photographed image on the basis of electrical signals created by the image sensors 112 and 122.

That is to say, when the ADC converts analog electrical signals output from the image sensor 112 (122) into digital signals and successively stores them in the buffer memory, the image processing engine accomplishes a so-called development process on the buffered digital data and accomplishes image quality adjustment and data compression.

The image memory 230 is composed of a memory device such as RAM or flash memory, for example, and temporarily stores photographed image data generated by the image processing unit 220 and image data processed by the controller 210.

The image output unit 240 is composed, for example, of an RGB signal generating circuit, and converts image data stored in the image memory 230 into RGB signals and outputs such to a display screen (below-described display unit 310 or the like).

The memory unit 250 is composed, for example, of a memory device such as ROM (Read Only Memory) or flash memory, and stores data and programs necessary for operation of the digital camera 1. In the present embodiment, operation programs executed by the controller 210 along with operation equations and parameters necessary for processes are stored in the memory unit 250.

The external memory unit 260 is composed of memory device that can be removed from the digital camera 1, such as a memory card or the like, and stores image data imaged by the digital camera 1 and the 3D modeling data created.

The interface 300 is a composition serving as an interface between the digital camera 1 and the user or external devices, and as shown in FIG. 2 is composed of a display unit 310, an external interface (I/F) 320 and an operation unit 330.

The display unit 310 is composed for example of a liquid crystal display device and displays and outputs various screens necessary for operation of the digital camera as well as live-view images when shooting, photographed images and 3D modeling data. In the present embodiment, the display of photographed images is accomplished on the basis of image signals (RGB signals) from the image output unit 240.

The external interface 320 is composed for example of a USB (Universal Serial Bus) connector and a video output terminal, and sends image data and 3D modeling data to external computer devices and displays and outputs photographed images and 3D modeling images and the like on external monitors.

The operation unit 330 is composed of various buttons composed on the outside surface of the digital camera 1, and creates input signals corresponding to operation by the user of the digital camera 1 and inputs these to the controller 210. Buttons comprising the operation unit 330 include, for example, a shutter button for indicating a shutter operation, a mode button for designating the operation mode of the digital camera 1, and a ten-key and function buttons for accomplishing various settings beginning with settings for accomplishing 3D modeling.

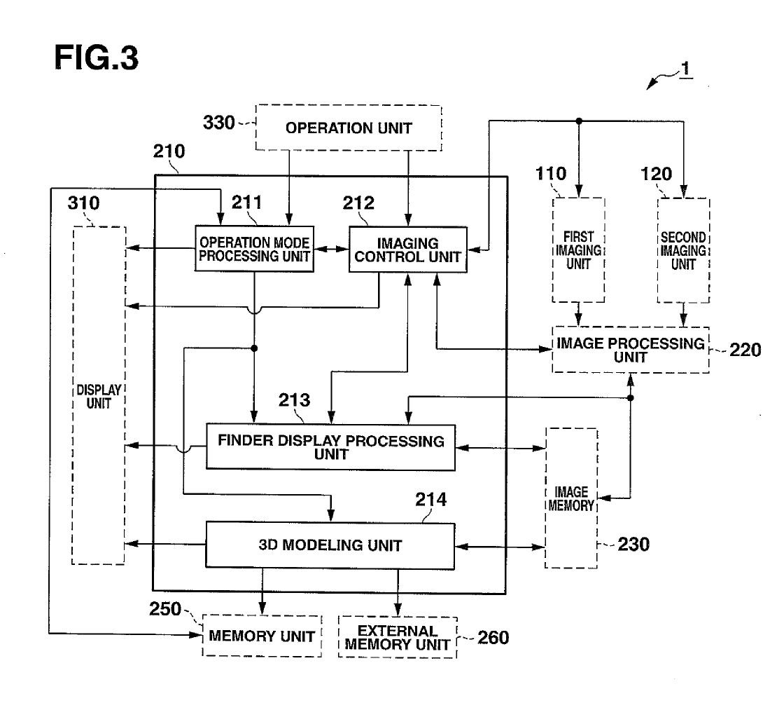

In the present embodiment, the below-describe processes are realized by the controller executing the operation programs stored in the memory unit 250, and the functions realized by the controller 210 in this case are described with reference to FIG. 3.

FIG. 3 is a function block diagram showing the functions realized by the controller 210. Here, the functional composition necessary to realize functions for extracting the subject image from images photographed by the compound-eye camera are shown. In this case, the controller 210 functions as an operation mode processing unit 211, an imaging control unit 212, a finder display processing unit 213 and a 3D modeling unit 214.

By working together with the display unit 310, the operation mode processing unit 211 accomplishes the set screen display for each designated operation mode and screen displays necessary to indicate to the user of the digital camera 1 the various operation modes the digital camera 1 possesses. In addition, by working together with the operation unit 330, the operation mode processing unit 211 recognizes the operation mode designated by the user, reads from the memory unit 250 the operation equations and programs necessary to execute this operation mode, and loads these into the main memory device (memory) of the controller 210.

In the present embodiment, the assumption is that an operation mode that accomplishes 3D modeling from the photographed images (a 3D modeling mode) has been designated by the user after imaging by shooting by the digital camera 1. The functional composition of the controller 210 explained below is the functional composition realized by the operation mode processing unit 211 executing the loaded program in accordance with the 3D modeling mode being designated.

The imaging control unit 212 executes an imaging operation in the digital camera 1 by controlling the imaging action unit 100 (first imaging unit 110 and second imaging unit 120). In this case, the imaging control unit 212 accomplishes control with various processes relating to imaging such as light measurement, focusing, automatic exposure, screen display during imaging and the like typically accomplished in a digital camera.

The finder display processing unit 213 accomplishes a finder display process unique to the imaging operation in the 3D modeling mode. That is to say, the digital camera according to the present embodiment is a so-called compact-type digital still camera, and the finder display is accomplished by the video image obtained by the imaging action unit 100 being displayed on the display unit 310. However, in the 3D modeling mode, the shape of the subject cannot be measured if the subject is not framed so as to be captured by both the first imaging unit 110 and the second imaging unit 120. Hence, the finder display processing unit 213 accomplishes a finder display so that the photographer can recognize whether or not framing satisfies those conditions.

The 3D modeling unit 214 accomplishes 3D modeling by matching the left and right images shot by the first imaging unit 110 and the second imaging unit 120. In this case, the 3D modeling unit 214 extracts characteristic points through template matching using the SSD (Sum of Squared Differences) method, for example, and 3D modeling is accomplished by creating polygons through Delaunay triangulation of the extracted characteristic points.

The above are the functions realized by the controller 210. In the present embodiment, the above-described various functions are realized by theoretical processing by the controller 210 executing programs, but these functions may be composed through hardware such as ASIC (Application Specific Integrated Circuits) or the like. In this case, out of the functions shown in FIG. 3 the function relating to image processing may be realized with the image processing unit 220.

The composition of the digital camera 1 described above is the composition necessary to realize the present invention, and compositions used in basic functions and various appended functions as a digital camera may be prepared as needed.

### Embodiment 1

The operation of a digital camera 1 having this kind of composition is explained below. An operation example is shown for the case in which the above-described 3D modeling mode is selected out of the operation modes of the digital camera 1. In this case, the user accomplishes shooting through the digital camera, and the digital camera accomplishes 3D modeling from the images shot.

In this case, the user shoots people, animals, art works or other three-dimensional objects as the subject using the digital camera 1 and the digital camera 1 creates from those photographed images 3D modeling data for displaying the subject as a three-dimensional image. When the 3D modeling mode is selected with the creation of such 3D modeling data as the objective, the imaging process for 3D modeling is executed in the digital camera 1.

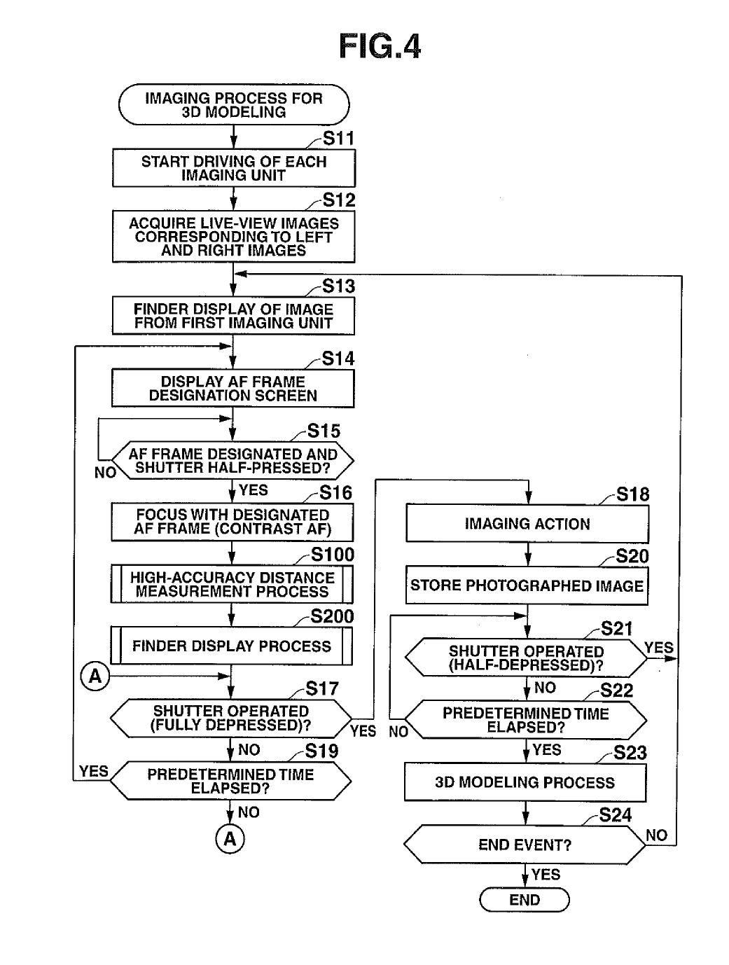

This imaging process for 3D modeling is explained with reference to the flowchart in FIG. 4. The imaging process for 3D modeling is started when the user of the digital camera 1 selects the 3D modeling mode by operating the operation unit 330. In this case, the operation mode processing unit 211 loads a program stored in the memory unit 250, and through this the various function compositions shown in FIG. 3 are realized and the below process is executed.

When processing begins, the imaging control unit 212 starts driving the first imaging unit 110 and the second image unit 120 (step S11) and through this acquires a live view image corresponding to the left and right images through operation of the various imaging units (step S12).

As shown in FIG. 1, in the digital camera 1 according to the present embodiment, the lens of the first imaging unit 110 is positioned on the left side facing the subject and the lens of the second imaging unit 120 is positioned on the right side facing the subject. In this case, distance (base line length) between the lenses correspond to parallax seen with the naked eye, so the photographed image obtained by the first imaging unit 110 is the image corresponding to the left eye field of view (the left eye image), while the photographed image obtained by the second imaging unit 120 is the image corresponding to the right eye field of view (the right eye image). Below, the photographed image obtained by the first imaging unit 110 is called “photographed image CP1” and the photographed image obtained by the second imaging unit 120 is called “photographed image CP2.”

The left and right images obtained by the first imaging unit 110 and the second imaging unit 120 are processed by the image processing unit 220 and are successively recorded in the image memory 230. The finder display processing unit 213 accomplishes a finder display by acquiring only the photographed image obtained by the first imaging unit 110 (the left eye image) out of the left and right images recorded in the image memory 230 (step S13). The finder display here is a normal finder display to enable the user to capture the subject.

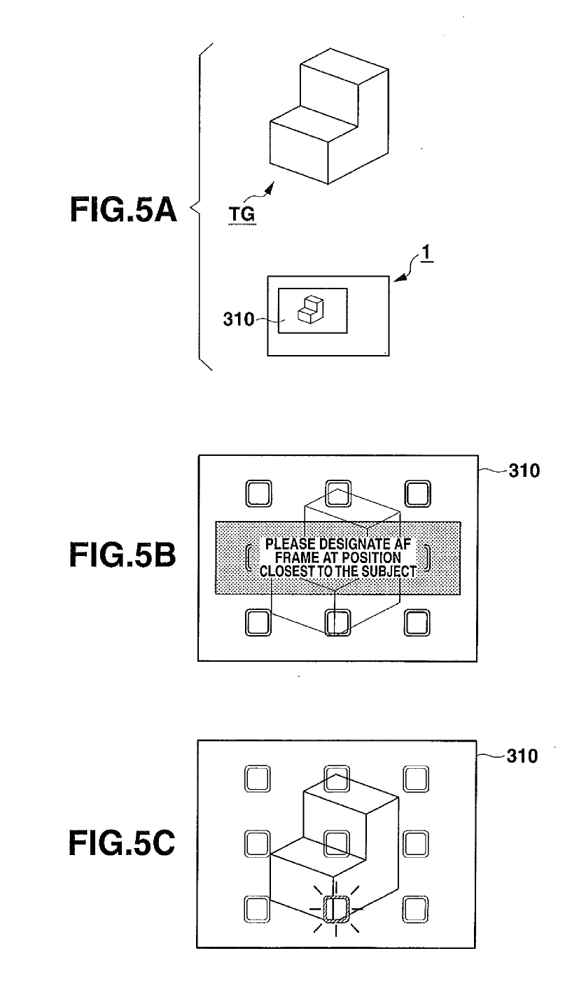

In the present embodiment, a photography scene such as that shown in FIG. 5A is assumed. That is to say, the three-dimensional position and shape of the subject TG are estimated and 3D modeling data is created by photographing this subject TG with the digital camera 1 that is a stereo camera with the object that is the subject of acquisition of the 3D modeling data as the subject TG. In this case, a photographed image showing the subject TG obtained by the first imaging unit 110, as shown in FIG. 5A, is displayed on the display unit 310 for the finder display of step S13.

When this kind of normal finder display is accomplished, the finder display processing unit 213 displays the AF frame on the finder screen and displays on the display unit 310 the AF frame designation screen (FIG. 5B) showing a message prompting the designation of the AF frame corresponding to the position closest to the subject (step S14). Here, assume that nine AF frames are displayed on the finder screen. The AF frames are used for the photographer to designate a measurement position through AF, and are realized through commonly known technology typically used in a general digital camera.

The photographer designates an AF frame corresponding to a position on the subject TG whose distance is closest to the digital camera 1 as shown in FIG. 5C, for example, by operating the ten key of the operation unit 330, and accomplishes a half-press operation of the shutter button (operation unit 330) in order to indicate the start of the measurement operation. When this operation is undertaken (step S15: Yes), the imaging control unit 212 controls the imaging action unit 100, scans at least the focus lens comprising the first imaging unit 110 within the movable range and finds the focus position with the highest image contrast in the designated AF frame. In other words, through so-called contrast AF, the focus action is accomplished so as to focus in the designated AF frame (step S16).

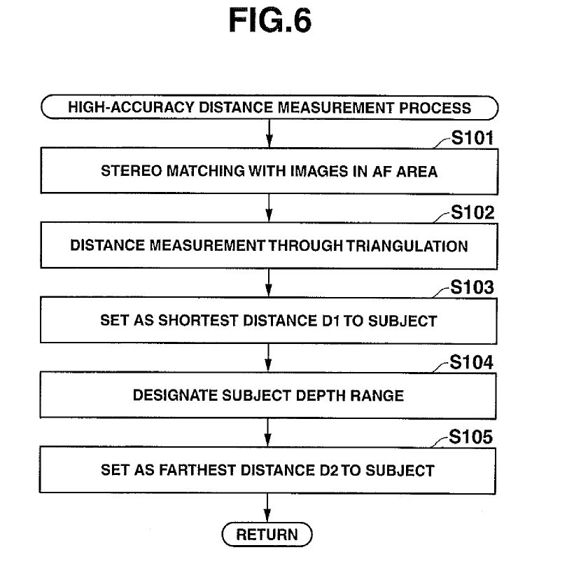

In regular photography with a digital camera, focusing is accomplished through measurements using this kind of contrast AF. However, when creating 3D modeling data of the subject TG that is a three-dimensional object, measurements through contrast AF do not have sufficient accuracy. Hence, a high-accuracy distance measurement process is executed in order to accomplish measurement with greater accuracy (step S100). This high-accuracy distance measurement process is explained with reference to the flowchart shown in FIG. 6.

When the process begins, the finder display processing unit 213 searches for the position corresponding to the designated AF frame on the photographed image CP2 by accomplishing stereo matching between the image in the AF frame designated on the photographed image CP1 and the photographed image CP2 (step S101). Here, because the position on the subject TG closest to the digital camera 1 is designated by the AF frame, the same position is specified on both images with a discrepancy corresponding to parallax.

The stereo matching accomplished here uses commonly known technology typically accomplished in the field of creating three-dimensional images, and for example an arbitrary method such as a normalizing correlation method or a direction symbol correlation method may be employed. In addition, because the distance range is obtained albeit with low precision through the contrast AF accomplished in step S16, the process relating to stereo matching can be undertaken at high speed because the search range in the stereo matching action in step S101 is limited by that distance range.

By specifying the position on the subject TG whose distance is closest from the digital camera 1 for both the photographed image CP1 and the photographed image CP2 through stereo matching, the finder display processing unit 213 accomplishes measurements through a triangulation method (step S102). That is to say, the distance to the position on the subject TG corresponding to the designated AF frame is computed by accomplishing a triangulation computation with the parallax of the positions determined through stereo matching, the current angle of view (lens focal length) and the base line length as factors. This kind of measurement through triangulation normally has higher precision than measurement through contrast AF accomplished in step S16. The finder display processing unit 213 sets the distance calculated in this manner as the shortest distance D1 to the subject TG (step S103).

Because the subject TG is a three-dimensional object, there is depth with respect to the digital camera 1. Hence, in order to create accurate 3D modeling data for the subject TG as a whole, it is necessary to take into consideration distances corresponding to the depth of the subject TG. In this case, it is impossible to accurately measure to the farthest distance corresponding to the depth of the subject TG through the influence of subject field depth created by the angle of view (lens focal length distance) and stop at this time with measurements by contrast AF such as that accomplished in step S16.

Hence, in the present embodiment, the finder display processing unit 213 designates the depth range of the subject TG based on more precise distance information obtained through triangulation (step S104). Here, the depth range of the subject TG is designated for example by applying a predetermined multiplier to the shortest distance D1 obtained in the processes in steps S101 to S103. The multiplier used here is arbitrary, and for example may be a fixed value or may be a value selected by the user. When designating the multiplier, it is possible to estimate the upper limit of the size of the subject TG contained in the angle of view on the basis of the angle of view and the shortest distance D1 at this time, so the multiplier that is the depth range corresponding to the size may be found through computation and designated.

The finder display processing unit 213 sets the distance obtained by multiplying the shortest distance D1 by this multiplier as the farthest distance D2 indicating the distance to the position on the subject TG that is farthest from the digital camera 1 (step S105) and returns to the flow of the imaging process for 3D modeling (FIG. 4).

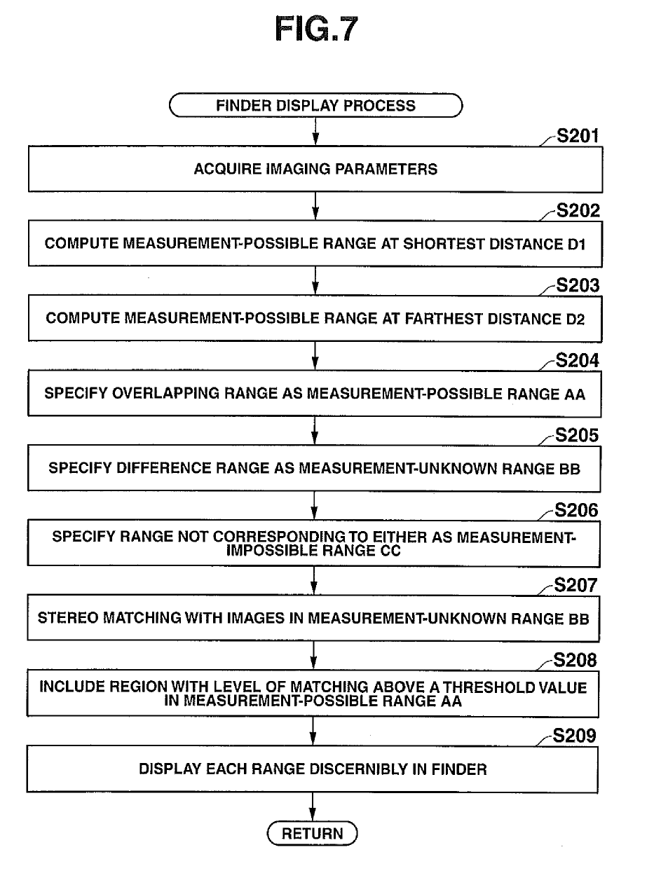

In the imaging process for 3D modeling, a finder display process for accomplishing a finder display that can recognize whether or not the framing is such that shape measurement in 3D modeling can be accurately accomplished is repeatedly executed (step S200). This finder display process is explained with reference to the flowchart shown in FIG. 7.

When the process begins, the finder display processing unit 213 acquires the current imaging parameter by inquiring of the imaging control unit 212 (step S201). The imaging parameter acquired here primarily specifies the current angle of view, and for example is the focal length (zoom value) of the lens.

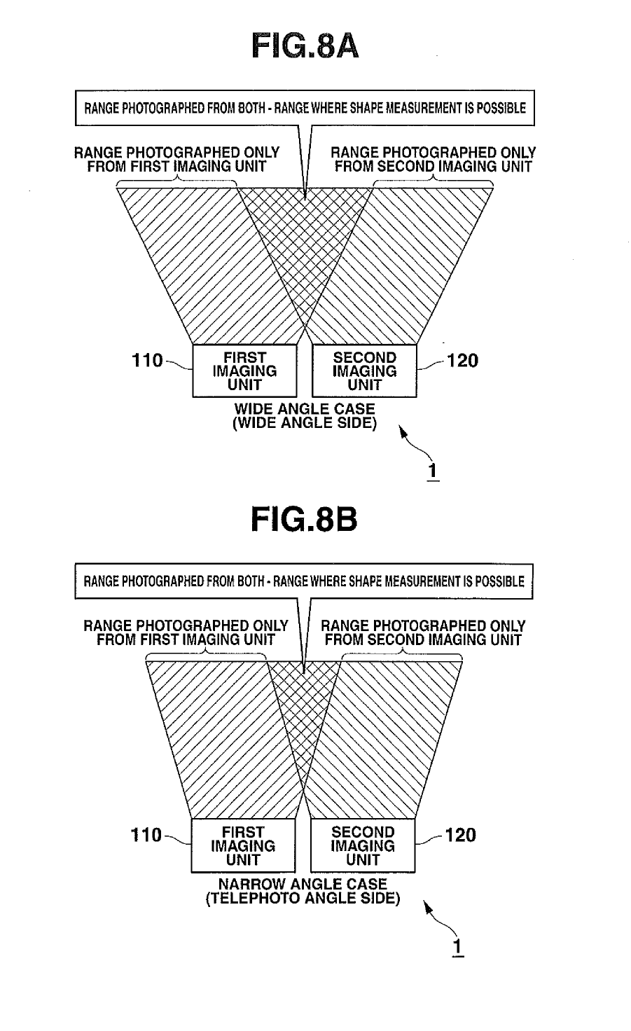

The reason the imaging parameter relating to the angle of view is necessary is because the imaging range of the first imaging unit 110 and the second imaging unit 120 differ depending on the angle of view. FIGS. 8A and 8B schematically show the imaging range when the digital camera 1 is viewed from above, with FIG. 8A showing an example of the imaging range when the angle of view is relatively wide (that is to say, when the lens focal length is on the wide-angle side) and FIG. 8B showing an example of the imaging range when the angle of view is relatively narrow (that is to say, when the lens focal length is on the telephoto side).

As shown in FIGS. 8A and 8B, in the digital camera 1 composed as a stereo camera by the first imaging unit 110 and the second imaging unit 120, it is possible to accomplish shape measurement for 3D modeling for a subject in the area (overlap area) where the imaging range of the first imaging unit 110 and the imaging range of the second imaging unit 120 overlap (hereafter called the “measurement-possible range”). However, for subjects in the area (non-overlap area) where the imaging range of the first imaging unit 110 and the imaging range of the second imaging unit 120 do not overlap, it is impossible to accomplish shape measurement because the subject is only seen by either the first imaging unit 110 or the second imaging unit 120 (hereafter called the “measurement-impossible range.”).

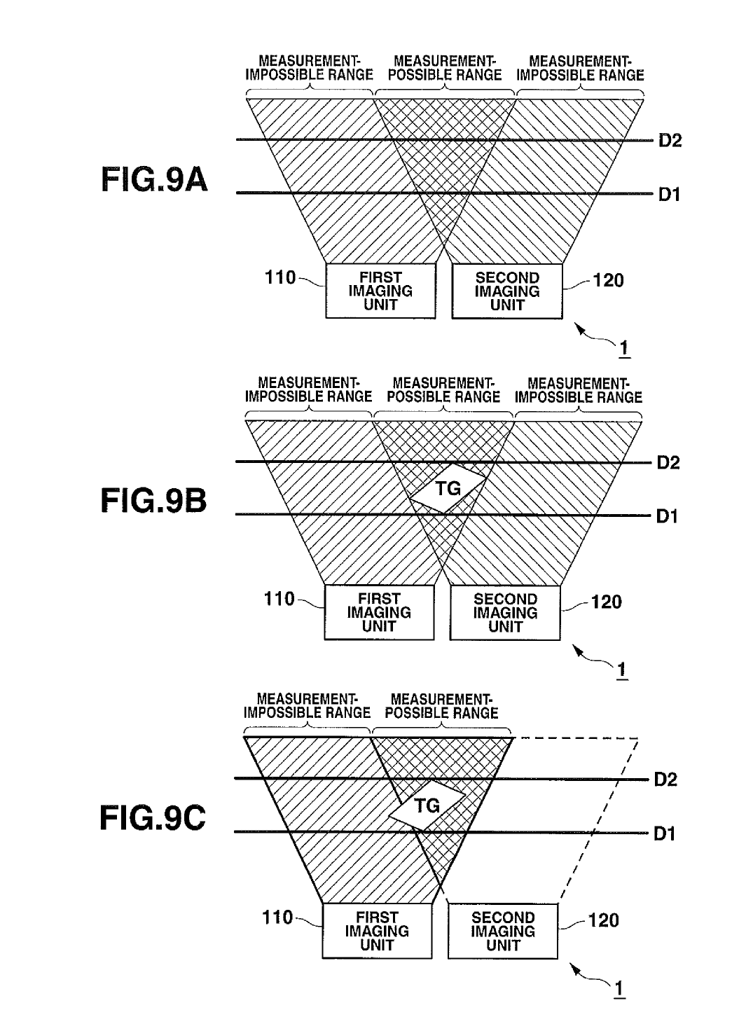

Determining between the two categories of whether the subject framing was in the overlap area or in the non-overlap area existed from before, but when 3D modeling is the objective, it is necessary to take that depth into consideration because a three-dimensional object is the subject. That is to say, for example as shown in FIG. 9A, the relationship between the overlap area (measurement-possible range) and the non-overlap area (measurement-impossible range) changes depending on distance, and in the case of the subject TG in the present embodiment, the shortest distance D1 and the farthest distance D2 do not necessarily belong to the same category.

In this case, with the present embodiment a photographed image CP1 obtained by the first imaging unit 110 is used as the finder image. Accordingly, for example when the framing is such that the entire subject TG is contained in the measurement-possible range within the range from the shortest distance D1 to the farthest distance D2 as shown in FIG. 9B, and when the framing is such that a portion of the subject TG within the range from the shortest distance D1 to the farthest distance D2 is contained in the measurement-impossible region, as shown in FIG. 9C, the subject TG is within the imaging range of the first imaging unit 110. Consequently, the photographer cannot recognize from the finder screen that this is the state shown in FIG. 9C.

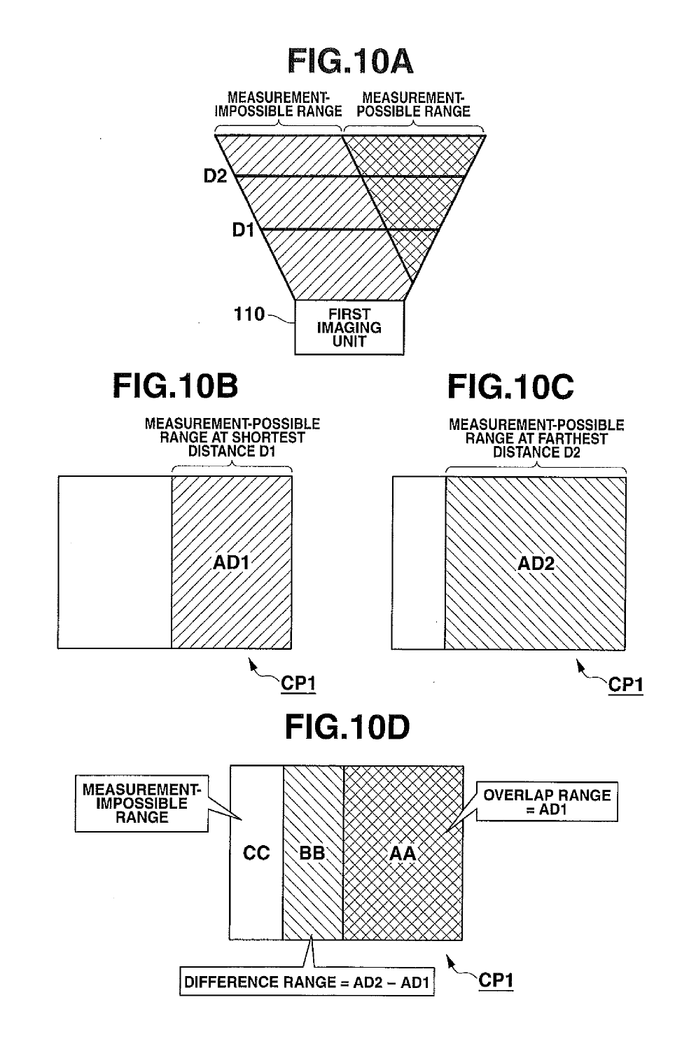

Hence, in the present embodiment, the processes from step S202 on are accomplished so that the photographer can recognize from the finder screen that this is a state an example of which is shown in FIG. 9C. As discussed above, with the present embodiment the photographed image CP1 obtained by the first imaging unit 110 is taken as the finder image, so an example is explained below of the relationship among the measurement-possible range, the measurement-impossible range, the shortest distance D1 and the farthest distance D2 as shown in FIG. 10 for the imaging range of the first imaging unit 110.

The finder display processing unit 213 computes the measurement-possible range at the shortest distance D1 (step S202) and applies the computed range on the photographed image CP1, as shown FIG. 10B. It is possible to find the measurement-possible range through computations using as parameters the baseline length, the shortest distance D1 obtained through triangulation and the angle indicated by the imaging parameters obtained in step S201. More specifically, the ratio in one dimension of the measurement-impossible region and the measurement-possible region on a line indicating the shortest distance D1 shown in FIG. 10A is found, and the one-dimensional range corresponding to the measurement-possible region is applied to the photographed image CP1, which is a two-dimensional image.

Next, the finder display processing unit 213 computes the measurement-possible range at the farthest distance D2 through a similar process (step S203), and applies the computed range to the photographed image CP1 as shown in FIG. 10C.

As shown in FIG. 10A, the ratio of the measurement-possible range at the line D1 and the ratio of the measurement-possible range at the line D2 differ. That is to say, the measurement-possible range (hereafter called effective range candidate AD2) at the farthest distance D2 as shown in FIG. 10C is wider than the measurement-possible range (hereafter called effective range candidate AD1) at the shortest distance D1 allocated to the photographed image CP1 as shown in FIG. 10B.

In this case, it is possible to accomplish shape measurement in the region where the effective range candidate AD1 and the effective range candidate AD2 overlap (in other words, in the effective range candidate AD1). Hence, with the present embodiment, this region is the measurement-possible range AA (effective range) (step S204, FIG. 10D).

On the other hand, for the region of difference between the effective range candidate AD2 and the effective range candidate AD1, there are cases where shape measurement can be accomplished and cases where this cannot be accomplished depending on the distance from the digital camera. Hence, in the present embodiment, this region is the measurement-unknown range BB (provisional effective range) (step S205, FIG. 10D).

In addition, the region which meets neither of the above-described conditions is where shape measurement can absolutely not be accomplished, so in the present embodiment, this kind of region is the measurement-impossible range CC (step S206, FIG. 10D).

In other words, with the present embodiment is becomes possible to discriminate not just the two categories of the past but also the measurement-unknown range. When the subject TG falls in the measurement-unknown range BB, whether or not measurement is possible can be learned through the distance to that part. This determination is accomplished by stereo matching with the photographed image CP2.

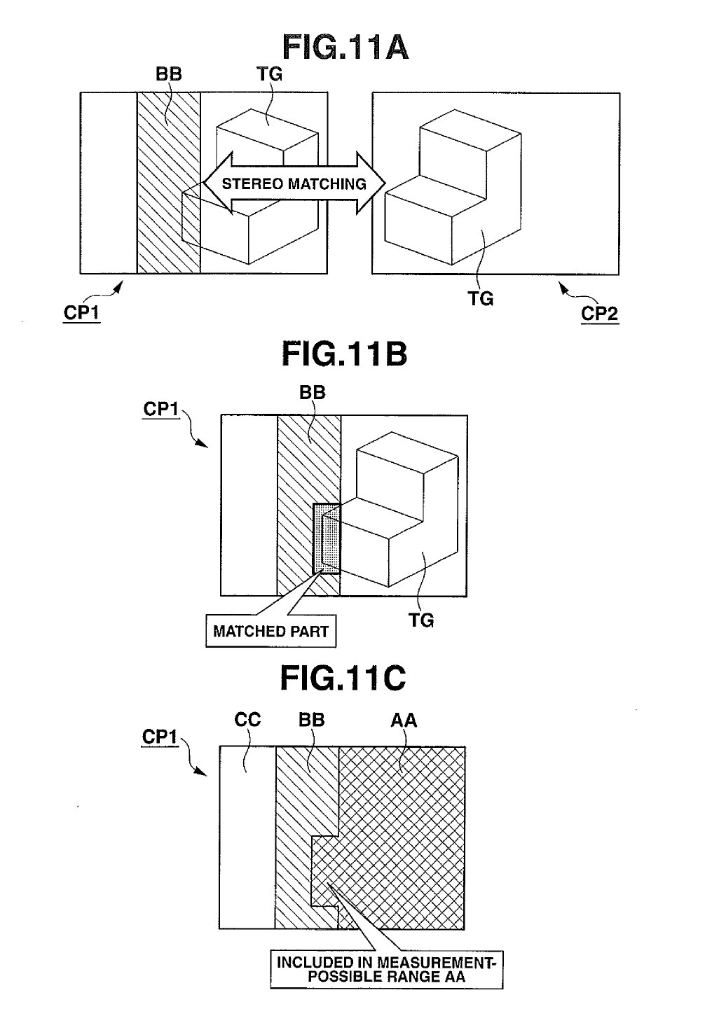

In this case, the finder display processing unit 213 accomplishes stereo matching between the photographed image CP2 and the image of the measurement-unknown range BB on the photographed image CP1, as shown in FIG. 11A (step S207). In this stereo matching, the process may be speeded up by dropping the resolution of each photographed image.

If the framing is such that all of the subject TG is captured in the photographed image CP2 as shown in FIG. 11A, for example, the part of the subject TG that falls in the measurement-unknown range BB on the photographed image CP1 is matched, as shown in FIG. 11B.

Because this kind of part has high matching, the finder display processing unit 213 captures that region in the measurement-possible range AA, as shown in FIG. 11C, with the imaging part where matching is at least as great as a predetermined threshold value as the matching region through the stereo matching of step S207 (step S208). In this case, that region is excluded from the measurement-unknown range BB.

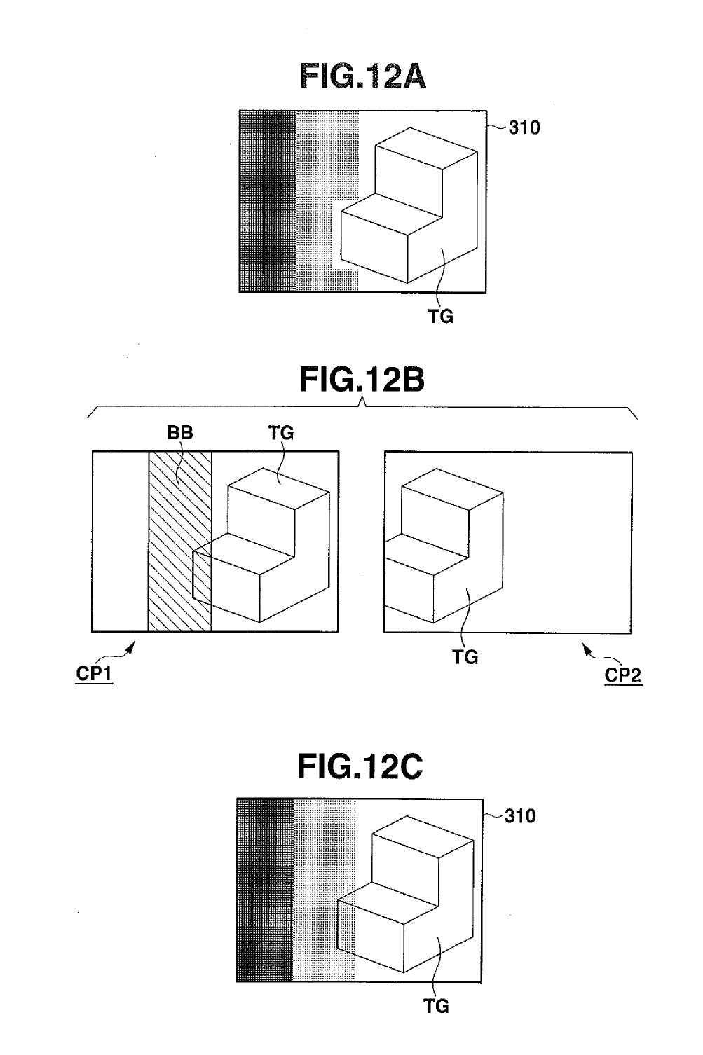

The finder display processing unit 213 accomplishes a finder display such that the measurement-possible range AA, the measurement-unknown range BB and the measurement-impossible range CC updated in this manner are discernible (step S209), and returns to the flow in the imaging process for 3D modeling (FIG. 4). An example of the finder display in this case is shown in FIG. 12A.

For example, taking the display region corresponding to the measurement-possible range AA as the normal display, a finder display is made such that the luminosity of the display region corresponding to the measurement-unknown rage BB is dropped more than the normal display and the luminosity of the display region corresponding to the immeasurable region CC is dropped even farther. With this kind of finder display, it is possible to accomplish shape measurement of the subject TG by making the framing such that the subject TG is included in the region where the normal display is made.

On the other hand, when the frame is such that the subject G is not all captured in the photographed image CP2 as shown in FIG. 12B, for example, it is impossible to find the region of the matching subject TG even if stereo matching with the image in the measurement-unknown range BB is accomplished with this kind of photographed image CP2. In this case, a finder display such as that shown in FIG. 12C results because extension of the measurement-possible range AA as in the example shown in FIG. 11C cannot be accomplished.

That is to say, the display is made such that a portion of the subject TG is captured in the display region where the luminosity is dropped on the photographed image CP1. Accordingly, the photographer can be aware from this kind of finder display that the framing is such that shape measurement of the subject TG cannot be accomplished.

In other words, if the finder display is like that shown in FIG. 12A, the photographer can determine that photography is fine with the current frame and in this case can fully depress the shutter button (operation unit 330), which is the operation for ordering the photography action.

In this case (step S17: Yes), the imaging control unit 212 accomplishes the photography action (step S18) by controlling the first imaging unit 110 and the second imaging unit 120. Here, the still images that become the left and right images are captured by simultaneously driving the first imaging unit 110 and the second imaging unit 120 with the existing photography parameters.

On the other hand, with the finder display such as that shown in FIG. 12C, because the determination can be made that shape measurement of the subject TG cannot be accomplished even with photography using the current framing, the photography instruction is not given. In this case, the photographer can change the framing by changing the angle or changing the lens focal length (zoom value).

In this kind of condition, the situation in which the shutter button (operation unit 330) cannot be fully depressed continues. In this case, (step S17: No; Step S19: Yes), there is a possibility that the distance to the subject TG could change due to changing the framing, so the finder display processing unit 213 accomplishes the processes starting at step S14. That is to say, the AF frame indication screen is again displayed and the photographer is caused to specify the most recent position of the subject TG.

As a result of the new framing, if a finder display such as that shown in FIG. 12A results, the imaging instruction is given and the imaging action is accomplished in step S18. The imaging control unit 212 stores the left and right images obtained through this imaging in the memory unit 250 or the like, for example (step S20).

Following this, when the half-pressing of the shutter button (operation unit 330) indicating the start of measurement is made within a predetermined time (step S21: Yes), the processes starting at step S13 are accomplished and imaging with the objective of creating 3D modeling data is similarly accomplished.

On the other hand, when a predetermined time has elapsed without the shutter button being half-depressed (step S12: No; step S22: Yes), the 3D modeling unit 214 creates 3D modeling data using the photographed images stored in step S20 (step S23).

In the present example, 3D modeling data is created when no imaging operation is accomplished, taking the processing load on the controller 210 into consideration. In addition, when there is surplus in the processing capacity of the controller 210, and when processes related to 3D modeling are accomplished by a dedicated processor separate from the controller 210, processes related to 3D modeling may be accomplished in parallel in the background of the imaging operation.

If, for example, a predetermined end event such as cancellation of the 3D modeling mode or turning off of the digital camera 1, does not occur (step S24: No), the processes starting at step S13 are again accomplished, and an imaging operation is accomplished accompanying a distance measurement action taking the depth of the subject TG into consideration.

Furthermore, the process ends as a result of the generation of an end event (step S24: Yes).

As described above, with the processes relating to the present embodiment, it is possible to accomplish accurate distance measurement by taking into consideration the depth of the subject that is a three-dimensional object, and even when the image photographed by one of the imaging units is used as the finder image, it is possible for the photographer to be aware of whether the framing is such that measurement of the shape of the subject can be made.

### Embodiment 2

With the above-described first embodiment, the shortest distance D1 to the subject TG was measured and the farthest distance D2, which reflects the depth of the subject TG, was found by multiplying the shortest distance D1 by a multiplier. In addition, for example by indicating with the AF frame the position on the subject closest to the digital camera 1 and the position on the subject TG farthest from the digital camera 1, the farthest distance D2 may also be measured by a process similar to the high-accuracy distance precision measurement process (FIG. 6).

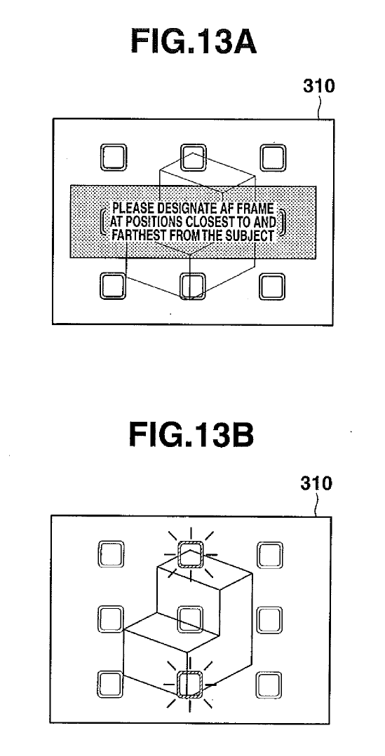

In this case, in step S14 of the imaging process for 3D modeling (FIG. 4), an AF frame specification screen for example such as the one shown in FIG. 13A is displayed on the display unit 310. In addition to displaying an AF frame similar to the case of Embodiment 1, for example a message indicating the position closest to and the position farthest from the subject is displayed. Furthermore, the photographer designates two AF frames, for example as shown in FIG. 13B, by operating the operation unit 330 such as a ten-key.

The finder display processing unit 213 finds the shortest distance D1 and the farthest distance D2 by accomplishing distance measurement through measurement by contrast AF in step S16 and through the high-accuracy distance measurement process (step S100, FIG. 6) for each of the two designated AF frames.

With this kind of method, it is possible to accomplish high-accuracy measurements through triangulation even for the farthest distance D2, and consequently it is possible to more accurately accomplish designation of the measurement-possible range AA, the measurement-unknown range BB and the measurement-impossible range CC, as shown in Embodiment 1.

As explained above, by applying the present invention as in the above-described embodiments, it is possible accomplish imaging for 3D modeling more effectively.

In this case, the distance to the subject portion designated by the AF frame is accomplished by triangulation through stereo matching using the left and right images of the stereo camera, so it is possible to accomplish distance measurement with greater precision than with contrast AF generally used in digital cameras, and it is possible to accomplish designation of the measurement-possible range (effective range) more accurately.

In addition, because an object that is the subject of 3D modeling is the subject, the measurement-possible range (effective range) is specified taking subject depth into consideration, so it is possible to specify the measurement-possible range (effective range) more accurately.

Because the measurement-possible range changes in the range corresponding to the depth of the subject, the range that is the difference between the measurement-possible range at the shortest distance to the subject and the measurement-possible range at the farthest distance to the subject becomes the measurement-unknown range (provisionally effective range), stereo matching of the image of this range with the photographed image not used as the finder image is accomplished and this part is added to the measurement-possible range (effective range) if there is a part that matches, so it is possible to specify more accurately measurement-possible ranges (effective ranges), specification of which is difficult through angles and view angles.

Furthermore, a finder display is made so that the photographer can recognize the specified measurement-possible range (effective range) and the measurement-unknown range (provisionally effective range), so it is possible to confirm at the time of imaging whether or not the subject is framed in the imaging range where measurement of the shape necessary for 3D modeling can be accomplished, and it is thus possible to increase imaging efficiency.

In designating the farthest distance reflecting the depth of the subject, it is possible to make the designation on the basis of the measured farthest distance, so in this case it is possible to accomplish designation of the measurement-possible range (effective range) taking into consideration subject depth with a small process load.

On the other hand, the farthest distance may be found through measurements by triangulation as well, and in this case it is possible to specify the measurement-possible range (effective range) using a more accurate farthest distance.

The above-described embodiment is one example, but the range of applications of the present invention is not limited to this. That is to say, various applications are possible, and all aspects of the embodiments are included within the scope of the present invention.

For example, in the above-described embodiments, a more accurate distance measurement through triangulation is made after making distance measurements through contrast AF in the designated AF frame, but distance measurement through triangulation may be made without making distance measurements through contrast AF or the like.

In addition, in the above-described first embodiment, the shortest distance D1 to the subject TG is measured and the farthest distance D2 is designated using the shortest distance D1 as a reference, but it would also be fine to have the farthest distance be the subject of distance measurement and to designate the shortest distance with reference to this.

In addition, in the above-described embodiments, an example was shown of an imaging device including a composition for creating 3D modeling data from photographed images, but it would be fine to not create 3D modeling data in the imaging device. That is to say, creation of 3D modeling data may be accomplished by an external device, and in this case it would be fine to have a composition supplying to this external device photographed images suitable for creating 3D modeling data obtained through imaging.

The present invention can be realized through an imaging device provided with compositions and functions similar to the imaging device in the above-described embodiments, and if this device has the composition of a stereo camera, it is possible for this device to function as an imaging device according to the present invention by applying programs to an existing imaging device (digital camera or the like). In this case, the device can be made to function as an imaging device according to the present invention by executing a program for realizing functions similar to the function of the above-described controller 210 in a computer (CPU or other controller) of an imaging device equipped with a composition similar to the digital camera 1 shown as an example in the above-described embodiments.

In the above-described embodiments, a digital still camera was shown as an example of an imaging device, but the form of the imaging device may be arbitrary so long as this device is provided with a composition similar to the digital camera 1 shown as an example in the above-described embodiments, and for example an imaging device according to the present invention can be realized by a digital video camera or the like.

In all of these cases, it is possible to cause an existing device to function as an image display device according to the present invention by applying a program. The method of applying such a program is arbitrary, and for example besides application by storing such on a memory medium such as a CD-ROM or a memory card, it is possible to apply such for example via a communications medium such as the Internet.

Having described and illustrated the principles of this application by reference to one or more preferred embodiments, it should be apparent that the preferred embodiments may be modified in arrangement and detail without departing from the principles disclosed herein and that it is intended that the application be construed as including all such modifications and variations insofar as they come within the spirit and scope of the subject matter disclosed herein.

What is claimed is:

1. An imaging device, comprising:
a stereo camera comprises a first imaging unit and a second imaging unit;
a finder display unit for displaying a first photographed image obtained through imaging by the first imaging unit on a finder screen as a finder image;
a distance measurement unit for measuring through triangulation a distance from the stereo camera to a part of a subject represented in a region indicated on the finder image;
a distance designation unit for designating a shortest distance and a farthest distance from the stereo camera to the subject on the basis of the distance obtained by distance measurement;
an effective range candidate specifying unit for specifying as effective range candidates ranges where the imaging ranges of the first imaging unit and the second imaging unit overlap; and
an effective range specifying unit for specifying the effective range candidate at the shortest distance and the effective range candidate at the farthest distance on the first photographed image, and specifying as the effective range a range where these effective range candidates overlap;
wherein the finder display unit displays on the finder screen information indicating the specified effective range.

2. The imaging device according to claim 1, wherein:
the effective range specifying unit further specifies as a provisional effective range a range comprising the difference between the effective range candidates; and
the finder display unit displays on the finder screen information indicating the specified provisional effective range.

3. The imaging device according to claim 1, wherein:
the effective range specifying unit further specifies as a provisional effective range a range comprising the difference between the effective range candidates; and
further comprises an effective range extension unit for extending the effective range so as to include an image part included in the specified provisional effective range when this image part is searched on a second photographed image obtained through imaging by the second imaging unit and a corresponding imaging part exists;
wherein the finder display unit displays on the finder screen information indicating the effective range after this extension.

4. The imaging device according to claim 1, wherein:
the distance measurement unit measures through triangulation the distance to that part of the subject where the distance from the stereo camera is the shortest, this subject being represented in a region designated on the finder image; and
the distance designation unit designates as the shortest distance the distance acquired by the distance measurement and designates as the farthest distance a distance found on the basis of this shortest distance.

5. The imaging device according to claim 1, wherein:
the distance measurement unit measures through triangulation the distance to that parts of the subject where the distance from the stereo camera is the shortest and the farthest, this subject being represented in a region designated on the finder image; and
the distance designation unit designates as the shortest distance the shorter of the distances acquired by distance measurement and designates as the farthest distance the longer of the distances acquired by distance measurement.

6. The imaging device according to claim 1, wherein:
by accomplishing stereo matching between an image of a region designated on the first photographed image obtained by imaging through the first imaging unit and a second photographed image obtained by imaging through the second imaging unit, the distance measurement unit specifies region corresponding to said region on the second photographed image and accomplishes triangulation.

7. The imaging device according to claim 3, wherein the effective range extension unit searches a part added to the effective range by accomplishing stereo matching between an image of the provisional effective range and the second photographed image.

8. A display method for accomplishing, in an imaging device comprising a stereo camera that comprises a first imaging unit and a second imaging unit, a finder display that makes an absence or presence of framing recognizable when a first photographed image obtained through imaging by the first imaging unit is displayed on a finder screen as a finder image, the display method comprising:
measuring a distance from the stereo camera to a part of a subject represented in a region designated on the finder image using triangulation;
designating the shortest distance and the farthest distance from the stereo camera to the subject on the basis of the distance obtained by the distance measurement;
specifying the range where the imaging ranges of the first imaging unit and the second imaging unit overlap as an effective range candidate;
specifying the effective range candidate at the shortest distance and the effective range candidate at the farthest distance on the first photographed image;
specifying the range where the effective range candidates overlap as the effective range; and
displaying information indicating the specified effective range on the finder screen.

9. A non-transitory computer-readable recording medium having stored thereon a program that is executable by a computer of an imaging device which comprises a stereo camera and a finder display unit, wherein the stereo camera comprises a first imaging unit and a second imaging unit, wherein the finder display unit is configured to display as a finder image a first photographed image obtained through imaging by the first imaging unit on a finder screen, wherein the program is executable by the computer to cause the computer to perform functions comprising:
measuring a distance from the stereo camera to a part of a subject represented in a region designated on the finder image using triangulation;
designating the shortest distance and the farthest distance from the stereo camera to the subject on the basis of the distance obtained by the distance measurement;
specifying the range where the imaging ranges of the first imaging unit and the second imaging unit overlap as an effective range candidate;
specifying the effective range candidate at the shortest distance and the effective range candidate at the farthest distance on the first photographed image;
specifying the range where the effective range candidates overlap as the effective range; and
displaying information indicating the specified effective range on the finder screen.
